(19) United States
(12) Patent Application Publication
(10) Pub. No.: US 2008/0222655 A1
(43) Pub. Date: Sep. 11, 2008

(54) Information Processing Apparatus and Information Processing Method

(75) Inventor: Hideki SATO, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/037,491

(22) Filed: Feb. 26, 2008

(30) Foreign Application Priority Data
Mar. 7, 2007 (JP) 2007-056601

(51) Int. Cl. G06F 3/00

(52) U.S. Cl. 719/318

(57) ABSTRACT

An information processing apparatus is provided that is capable of transferring a file to a receiving apparatus without a file location in the receiving apparatus being specified by a user every time the user stores the file and that is capable of automatically transmitting an e-mail notifying the file location to a recipient's e-mail address previously registered when the new file is stored in the file location of the receiving apparatus. The information processing apparatus has an information memory unit memorizing a location information identifying a location in which a file is to be stored and an e-mail recipient information associated with the location information, a file information memory unit memorizing a file information comprised of a file location information of a location in which the file is stored and a date and time as to when the file is stored, a storing determination unit watching the file information to determine whether the file is newly stored, and a communication unit transmitting an e-mail including the file information about the newly stored file to a user whose email address is previously registered in the e-mail recipient information where the storing determination unit determines that the file is newly stored in the file location.

### BACKGROUND OF THE INVENTION

1. Field of the Invention

The present invention relates to an information processing apparatus and an information processing method for sending an e-mail.

2. Description of Related Art

Where a user uses a conventional information processing apparatus to scan a document such as a meeting minute to store the scanned document as a file in a file server and send an e-mail notifying a directory and filename of the stored file, the user is first required to configure the directory containing the file and a recipient's e-mail address with an operation panel of the apparatus, subsequently scans the document, converts the scanned document into the file, stores the file in the specified file server, and thereafter transmits the e-mail to the specified recipient address.

As a technology related to the above conventional technology, Japanese Un-examined Patent Application Publication No. H11-98218 discloses a transferring apparatus that allows a user to freely select a data transfer destination in which a receiving apparatus stores a data transferred from the transferring apparatus and that does not require the user to change the configuration about the data transfer location even where the data structure in the receiving apparatus has been changed.

The transferring apparatus disclosed in Japanese Un-examined Patent Application Publication No. H11-98218 has a request means requesting the receiving apparatus receiving a data transferred from the transferring apparatus to reply a data structure of the receiving apparatus, a display means displaying the data structure replied in response to the request of the request means, a selection means with which the user selects a desired data transfer destination from the data structure displayed on the display means, and a transfer means transferring the data to the directory selected by the selection means.

The transferring apparatus structured as described above can request the receiving apparatus to reply the data structure of the receiving apparatus and allows the user to select the desired data transfer destination from the data structure replied in response to the request, so that the transferring apparatus can transfer the data to the selected data transfer destination in the receiving apparatus.

The transferring apparatus, however, requires the user to specify the data transfer destination in the receiving apparatus and to transfer the data every time the user stores the data in the receiving apparatus, thus being troublesome for the user. Furthermore, where a storing unit of the receiving apparatus storing the data has a complicated hierarchical data structure, the user may possibly make mistakes in specifying the directory.

### SUMMARY OF THE INVENTION

This invention is made in consideration of such problem, and it is the object of the present invention to provide an information processing apparatus that enables a file to be transferred without a file location specified in the receiving apparatus every time the user stores the file and automatically sends the file location of the file via an e-mail to a previously registered recipient's e-mail address when the new file is stored in the file location in the receiving apparatus.

In order to solve the above problem, the information processing apparatus of the present invention has an information memory unit memorizing a location information identifying a location in which a file is to be stored and an e-mail recipient information associated with the location information, a file information memory unit memorizing a file information comprised of a file location information of a location in which the file is stored and a date and time as to when the file is stored, a storing determination unit watching the file information to determine whether the file is newly stored, and a communication unit transmitting an e-mail including the file information about the newly stored file to a user whose email address is previously registered in the e-mail recipient information where the storing determination unit determines that the file is newly stored in the file location.

The information processing apparatus of the present invention has the information memory unit memorizing the location information identifying the location in which the file is to be stored and the e-mail recipient information associated with the location information and the file information memory unit memorizing the file information comprised of the file location information of the location in which the file is stored and the date and time as to when the file is stored.

The e-mail recipient information is stored with association with the location information identifying the location in which the file is to be stored. The e-mail is sent to the user whose email address is registered with association with the location of the stored file where the storing determination unit, hereinafter described, determines that the file is newly stored in the file location

The storing determination unit watches the file information. The file information is comprised of the file location information and the date and time as to when the file is stored. That is, the storing determination unit determines a state of storing of the files by watching the storing location and the storing date and time of the file newly stored based on the file information.

The image processing apparatus of the present invention can automatically transmit the file information via e-mail to the user who needs the file information without the file information being configured again every time the file is stored in the storing unit, and thus, when the file is stored, the image forming apparatus can reduce troublesomeness and mistakes in configuring the file location.

### DETAILED DESCRIPTION OF THE DRAWINGS

This invention may take physical form in certain parts and arrangements of parts, a preferred embodiment and method of which will be described in detail in this specification and illustrated in the accompanying drawings which form a part hereof, and wherein:

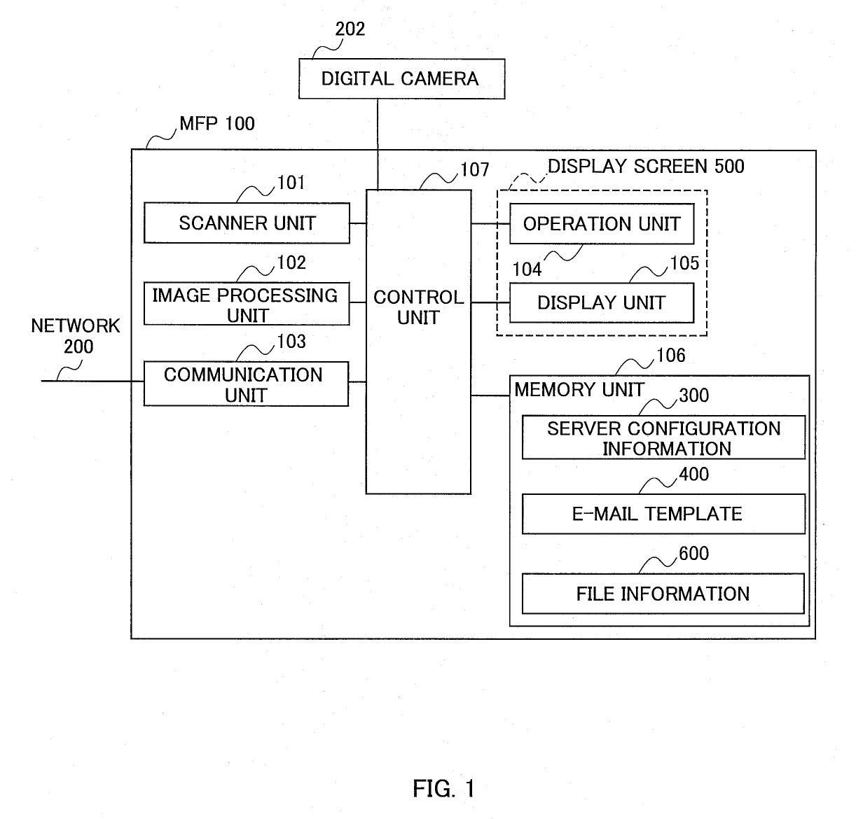

FIG. 1 is a block diagram showing a MFP according to the first embodiment of this invention;

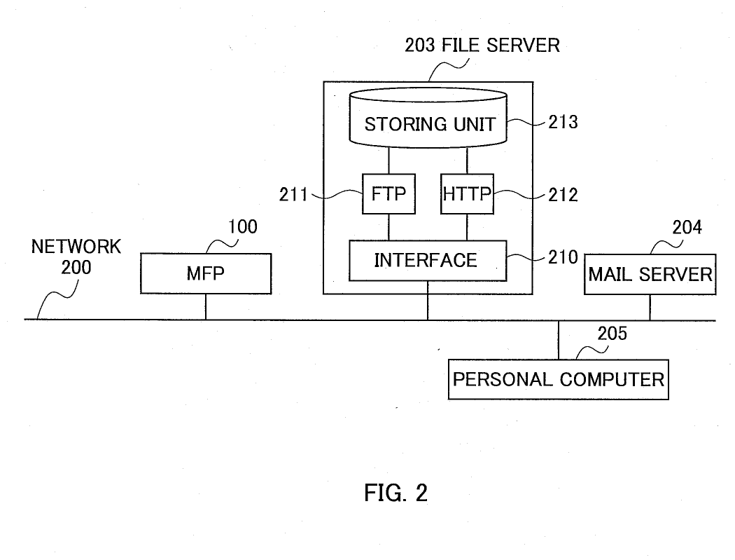

FIG. 2 is a diagram showing an example of a network configuration according to the first embodiment of this invention;

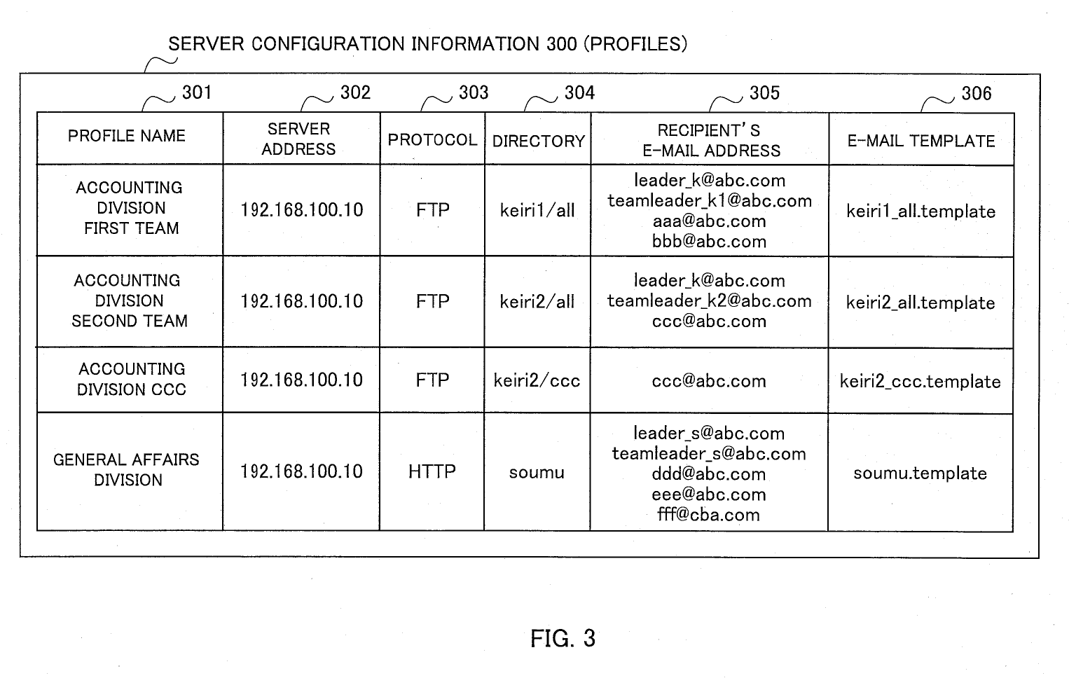

FIG. 3 is a diagram showing an example of file server configuration information according to the first embodiment of this invention;

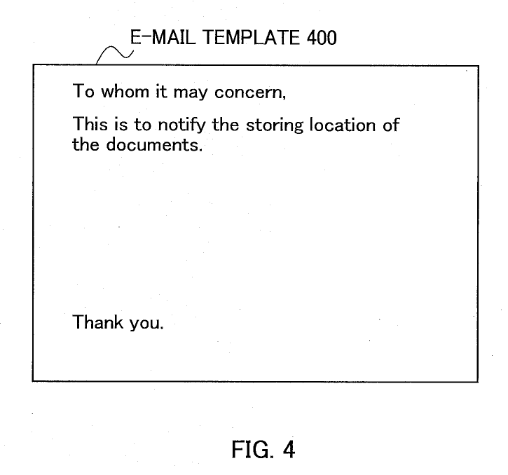

FIG. 4 is a diagram showing an example of an e-mail template according to the first embodiment of this invention;

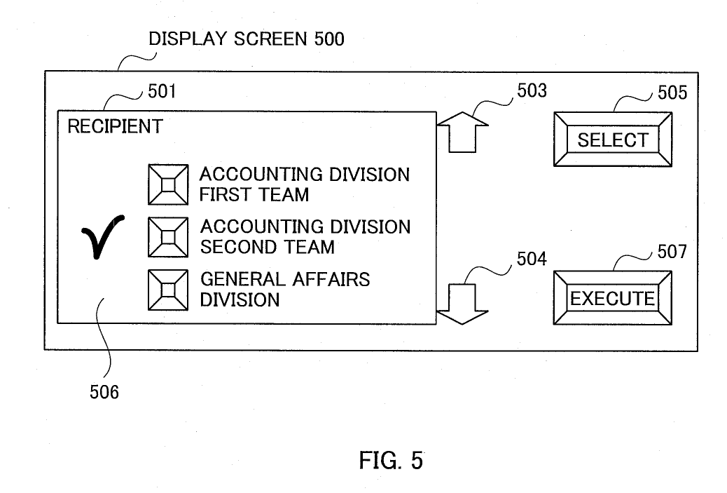

FIG. 5 is a diagram showing an example of a selection screen where a user causes the MFP according to the first embodiment of this invention to read out a document and transmit the document to a file server;

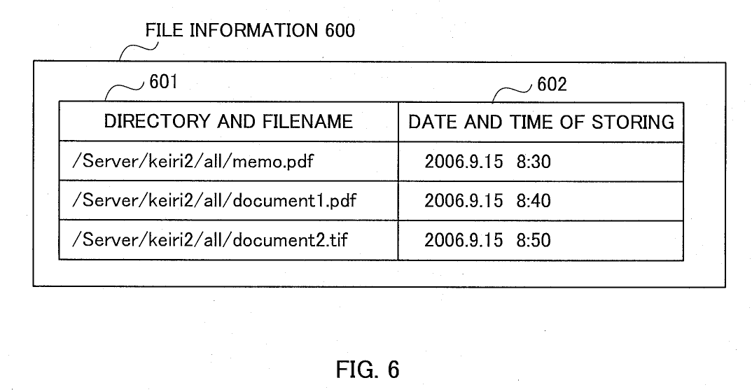

FIG. 6 is a diagram showing an example of file information according to the first embodiment of this invention;

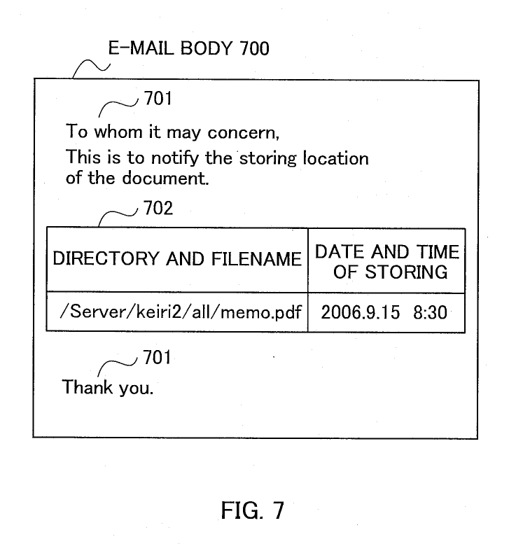

FIG. 7 is a diagram showing an example of a storing completion notification e-mail according to the first embodiment of this invention;

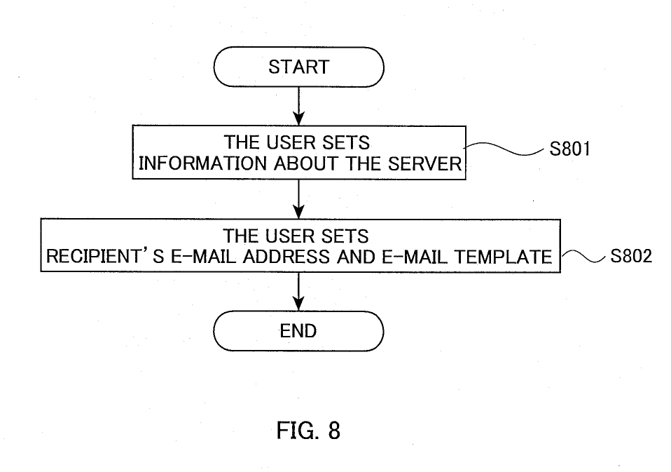

FIG. 8 is a flow chart of an initial configuration of the MFP;

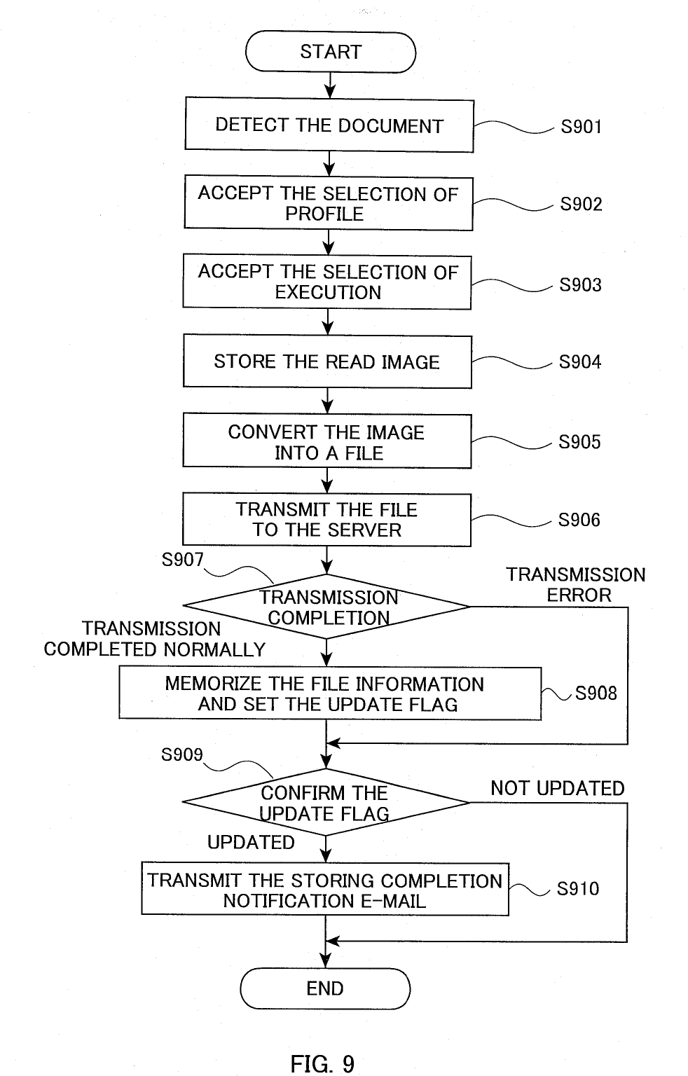

FIG. 9 is a flow chart from document scanning to storing completion notification e-mail transmission;

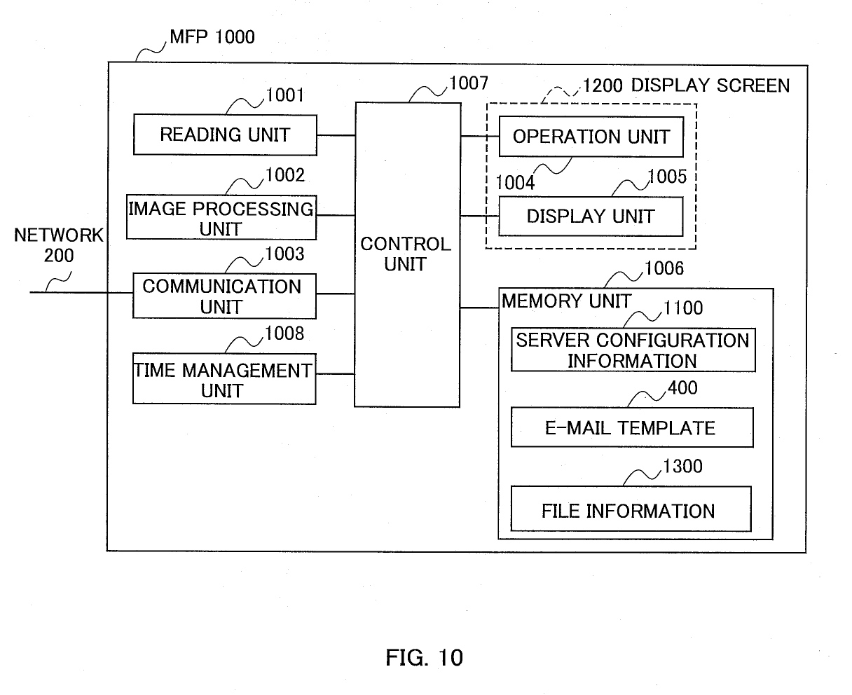

FIG. 10 is a block diagram of the MFP according to the second embodiment of this invention;

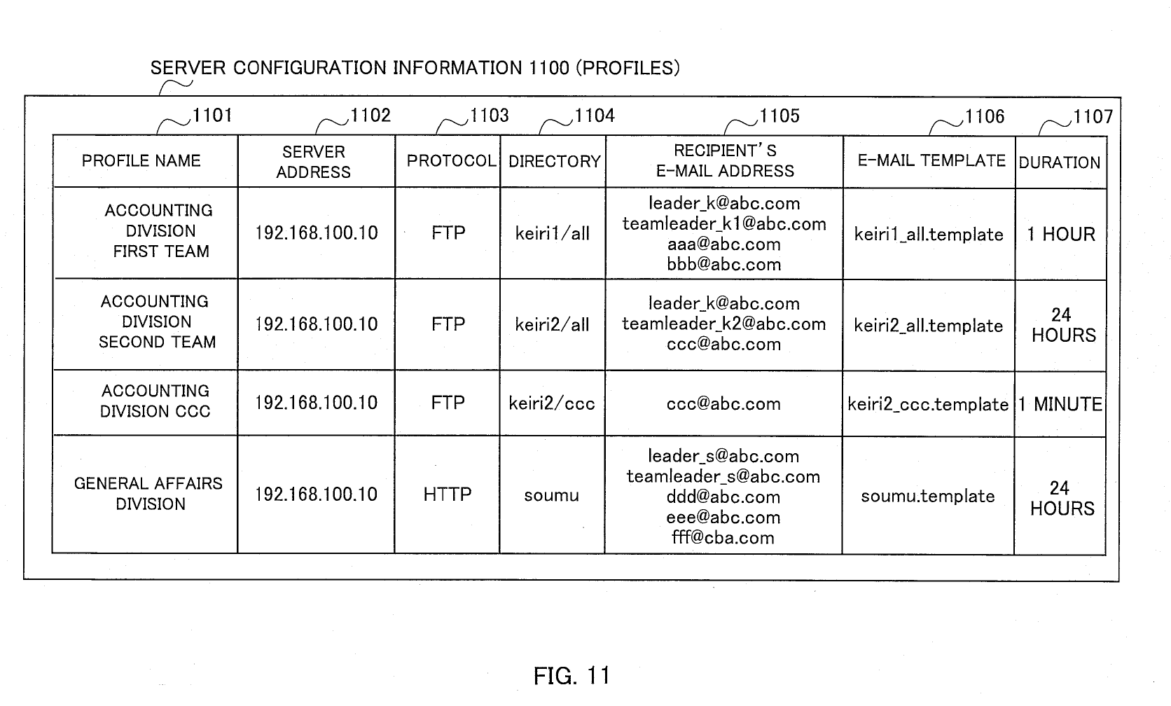

FIG. 11 is a diagram of an example of the file server configuration information according to the second embodiment of this invention;

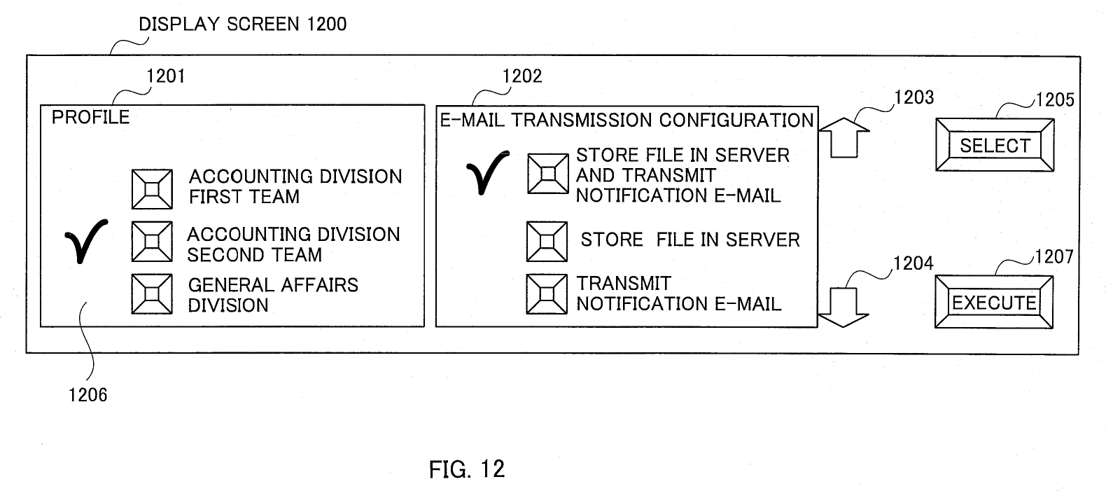

FIG. 12 is a diagram showing an example of the selection screen where a user causes the MFP according to the second embodiment of this invention to read out a document and transmit the document to the file server;

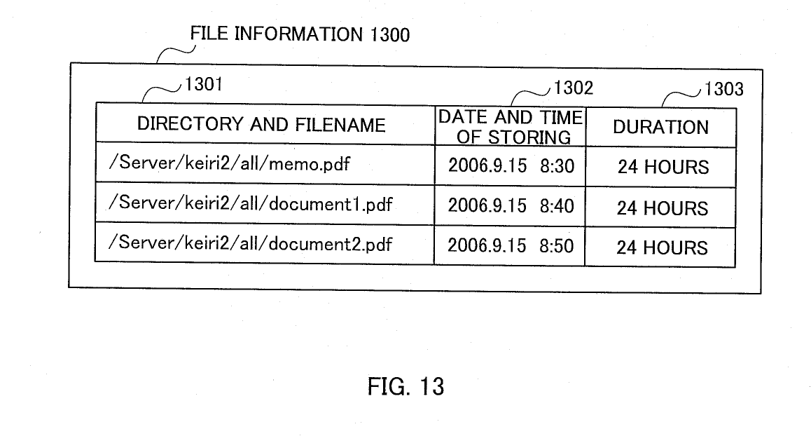

FIG. 13 is a diagram showing an example of file information according to the second embodiment of this invention;

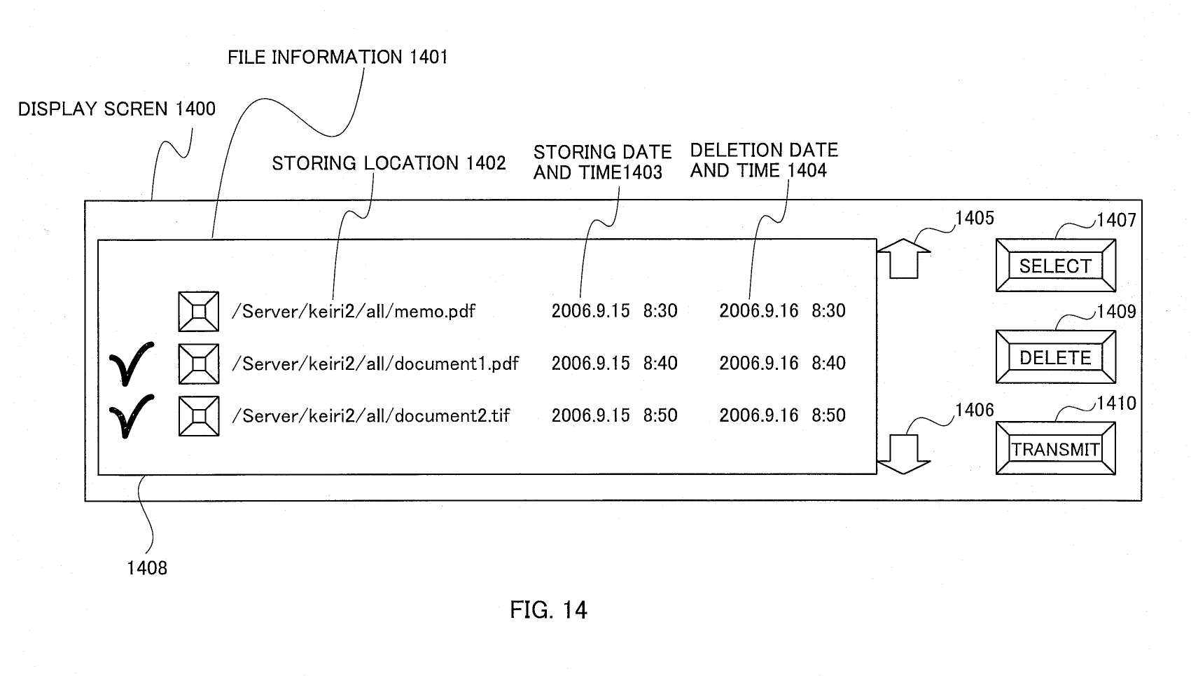

FIG. 14 is a diagram showing an example of the selection screen where only a function for sending the storing completion notification e-mail is executed according to the second embodiment of this invention;

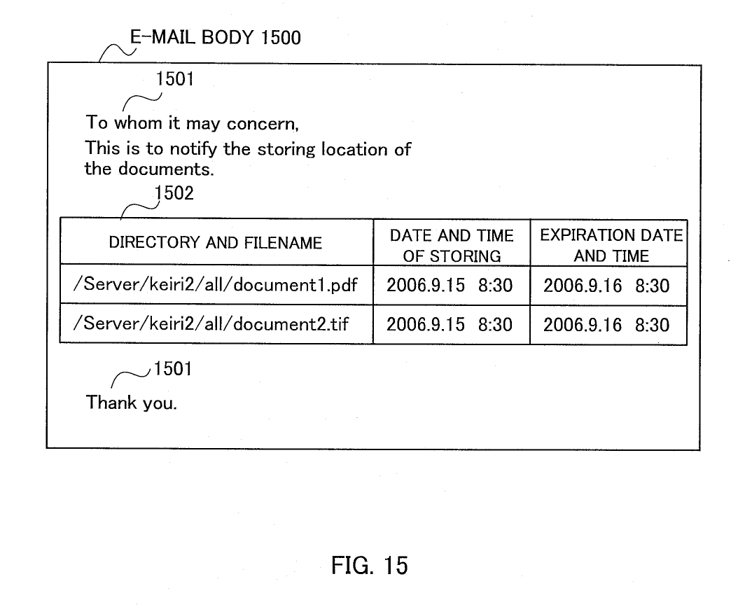

FIG. 15 is a diagram showing an example of the storing completion notification e-mail according to the second embodiment of this invention;

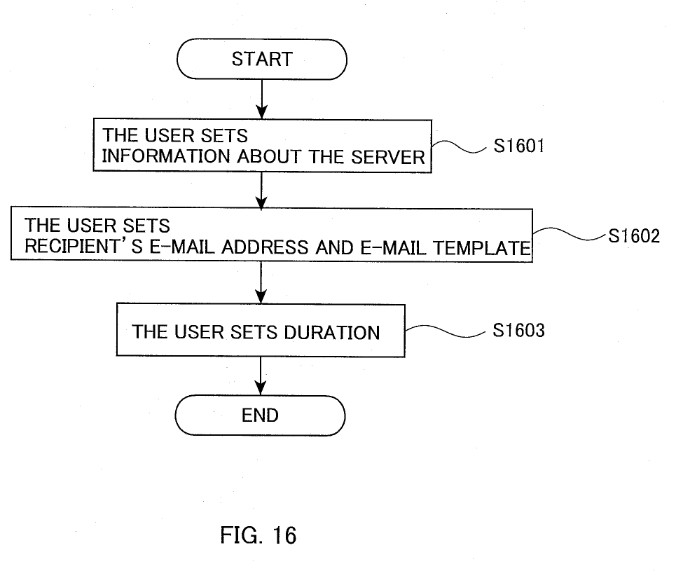

FIG. 16 is a flow chart of the initial configuration of the MFP; and

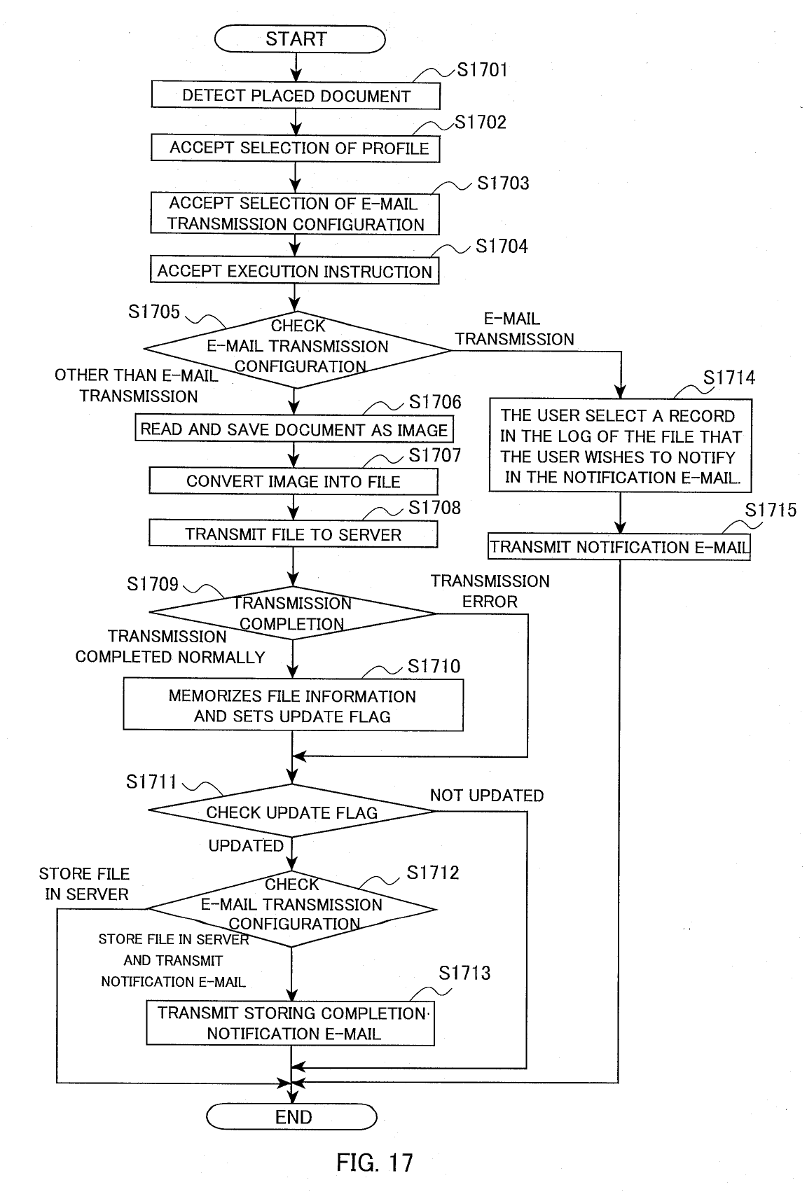

FIG. 17 is a flow chart up to a transmission of the single storing completion notification e-mail for the multiple files after the multiple files are transmitted to the file server.

### PREFERRED EMBODIMENTS

### First Embodiment

Embodiments according to the present invention are hereinafter described in detail with reference to the figures.

### First Embodiment

The first embodiment is hereinafter described with reference to FIGS. 1 to 7. The first embodiment is a case where the information processing apparatus is an MFP (Multi-Function Product/Printer/Peripheral) comprising a scanner, an image processing unit, a network interface, and an e-mail transmission unit.

FIG. 1 is a block diagram of the MFP used in the first embodiment. The MFP 100 has a scanner unit 101 reading a document, an image processing unit 102 converting the scanned document into a file, a communication unit 103 transmitting the converted file to a configured file server, an operation unit 104 with which a user selects a file server and instructs the MFP to start reading the document, a display unit 105 displaying a file server configuration and an e-mail transmission configuration, a memory unit 106 memorizing a file server configuration information 300, an e-mail template 400, and a file information 600, and a control unit 107 controlling various units. The communication unit 103 is connected to a network 200 to transmit the e-mail and the file converted from the read document. A digital camera 202 may be connected to the MFP via a USB cable and the like, or alternatively, the MFP may read files containing pictures taken by the digital camera 202 via a memory device such as a memory card and a compact flash card.

FIG. 2 shows an example of a network configuration according to the first embodiment of this invention. The network according to the first embodiment comprises the MFP 100 having a function as an information processing apparatus, a file server 203 having a storing unit 213, a mail server 204, and a personal computer 205.

The file containing the document read by the scanner unit 101 of the MFP 100 or the file of a picture taken by the digital camera 202 is transmitted to the file server 203 via the network 200.

The file server 203 is, for example, a FTP (File Transfer Protocol) file server and a HTTP (Hypertext Transfer Protocol) file server, and has an interface 210 connecting to the network, an FTP 211 and an HTTP 212 providing protocols for receiving the file, and the storing unit 213 described above.

After the file has been stored in the file server 203, the MFP 100 transmits to the mail server 204 an storing completion notification e-mail notifying that the file has been stored. The user uses the personal computer 205 to access the mail server 204 to receive and display the storing completion notification e-mail transmitted from the MFP 100. The file format of the file stored in the file server 203 is, for example, PDF (Portable Document Format), TIFF (Tagged Image File Format), or JPEG (Joint Photographic Experts Group).

FIG. 3 shows an example of the file server configuration information 300 used in the first embodiment. The file server configuration information 300 is stored in the memory unit 106. The file server configuration information 300 is comprised of multiple profiles, and each profile is comprised of items, namely, a profile name 301, a file server address 302, a protocol 303, a directory 304, a recipient's e-mail address 305, and an e-mail template 306.

The profile name 301 contains a character string displayed on the display unit 105. The file server address 302 contains an address of the file server 203 in which the file of the document scanned and converted by the MFP 100 and the file of the image taken by the digital camera 202 are stored. In the first embodiment, the file server address 302 is expressed as an IP (Internet Protocol) address, but is not limited thereto and can be expressed as host names, domain names, and the like.

The protocol 303 contains a protocol for transmitting the file to the file server 203 from the MFP 100. The directory 304 contains a directory in which the file is stored.

The recipient's e-mail address 305 contains a recipient's e-mail address of the storing completion notification e-mail transmitted after the file is stored in the file server 203 by the MFP 100. The e-mail template 306 contains a filename of a template file for the storing completion notification e-mail.

The file server configuration information 300 can be configured with a software keyboard displayed on a display screen 500 as hereinafter described. Alternatively, the user can configure a web-based configuration interface of the MFP 100 with his or her web browser of the personal computer 205 over the network.

FIG. 4 is an example of the e-mail template used in the first embodiment. One of the e-mail template files configured in the file server configuration information 300 is a template 400 covering a body part of the e-mail as shown in FIG. 4.

FIG. 5 shows an example of the selection screen where the MFP 100 according to the first embodiment reads the document and transmits the document as the file to the file server 203. The selection screen is displayed on, for example, an LCD (Liquid Crystal) display, and the display screen can be switched to display different contents depending on configurations and selections.

The display unit 105 displays a profile list 501 of the profile names 301 configured in the MFP 100. The user can select the profile name 301 by touching arrow buttons 503 and 504 to move up and down a cursor and touching a select key 505 to decide the selected profile. Where the user selects one of the profiles, a checkmark 506 is displayed. After the user has selected the profile, the user touches an execute button 507 to instruct the MFP to read of the document.

FIG. 6 is an example of the file information 600 used in the first embodiment. Where the file transmitted by the MFP 100 is successfully stored in the file server 203, information about the file stored in the file server is memorized as a record in the memory unit 106. The memory unit 106 contains a directory and filename 601 of the stored file and a storing date and time 602 as to when the file is stored. The e-mail is prepared based on the information memorized in the memory unit 106 and is sent to the recipient's e-mail address for notification.

FIG. 7 is an example of the storing completion notification e-mail used in the first embodiment. The MFP 100 makes an e-mail body 700 consisting of an e-mail body template 701 and file information 702 and transmits the e-mail to the mail server 204. The user receiving the e-mail on the personal computer 205 can know that the document has been stored in the file server 203, and can know the directory containing the stored file and the storing date and time as to when the file is stored.

Subsequently, the operation of the first embodiment is hereinafter described with reference to FIGS. 1 to 9.

FIG. 8 shows a processing flow of the initial configuration of the MFP 100. First, the file server configuration information 300 as shown in FIG. 3 is configured. The user may configure the file server configuration information 300 by inputting the information with the software keyboard displayed on the operation panel or by accessing the web-based configuration interface of the MFP 100 with the personal computer 205 over the network.

At step S801, the information about the file server 203 receiving the file transmitted by the MFP 100 is configured. That is, the profile name 301, the file server address 302, the protocol 303, and the directory 304 are configured.

At step S802, the recipient's e-mail address 305 corresponding to the directory is configured to allow transmission of the storing completion notification e-mail.

In addition to the recipient's e-mail address 305, the e-mail template 306 is configured. With the file server configuration information 300 thus configured, the user has only to select the profile name 301 to store the file in the configured directory and transmit the storing completion notification e-mail to the recipient's e-mail address.

FIG. 9 shows a processing flow from the reading of the document to the transmission of the storing completion notification e-mail. The MFP 100 detects that the document to be read is placed at step S901. Then, the user operates the operation panel to select the profile name 301 to determine the file server to which the document is to be transmitted as the file.

At step S902, the MFP 100 accepts the selection of for example, the profile name “accounting division second team” on the operation panel. Then, the user touches the execution button 507. In response, the MFP 100 accepts the selection of the execution at step S903.

The MFP 100 starts reading the document upon accepting the execution, and temporarily memorizes the scanned image in the memory unit 106 at step S904. The image processing unit 102 converts the memorized image into, for example, the file in PDF format at step S905.

Then, the MFP 100 transmits the converted file to the directory 304 in the file server address 302 under the protocol 303 at step S906. When the file has been stored in the file server, it is determined whether the transmission has been completed normally at step S907, and the file information is memorized in the memory unit 106 and an update flag is set at step S908.

The MFP 100 finally checks the update flag, and where the file information is determined to be updated at step S909, the MFP 100 transmits the storing completion notification e-mail to the recipient's e-mail address 305 at step S910. Where the file information is not updated, the e-mail is not sent.

With the first embodiment of the present invention as described above, the file server address and the directory can be configured to be associated with the recipient's e-mail address of the storing completion notification e-mail. Accordingly, the user does not need to configure such information all over again every time scanning the document and transmitting the scanned document to the file server, thus preventing the user from making mistakes in selecting the directory and enabling the recipient's e-mail address to be determined automatically depending on the associated directory to save troubles in these series of operations.

Next, the second embodiment of the present invention is hereinafter described with reference to FIGS. 10 to 15.

FIG. 10 is a block diagram of an MFP 1000 used in the second embodiment of the present invention. In addition to structures of the MFP 100 of the first embodiment in FIG. 1, the MFP 1000 has a time management unit 1008 managing duration for which a corresponding record in the file information is maintained.

An example of the network configuration of the second embodiment is omitted as being the same as the first embodiment.

FIG. 11 is an example of the file server configuration information used in the second embodiment. In addition to the file server configuration information 300 in FIG. 3, the file server configuration information 1100 has a duration 1107. The duration 1107 contains a time for which the MFP 1000 stores the corresponding record in the file information.

An example of the e-mail template of the second embodiment is omitted as being the same as the first embodiment.

FIG. 12 is an example of the selection screen where the MFP 1000 used in the second embodiment reads the document and transmits the file to the file server 203.

In addition to items displayed on the display screen 500 in FIG. 5, the display screen 1200 has an e-mail transmission configuration 1202. The e-mail transmission configuration 1202 is comprised of three items, namely, “STORE FILE IN SERVER AND TRANSMIT NOTIFICATION E-MAIL”, “STORE FILE IN SERVER”, and “TRANSMIT NOTIFICATION E-MAIL”.

Where “STORE FILE IN SERVER AND TRANSMIT NOTIFICATION E-MAIL” is chosen, the document is read and converted into the file which is then stored in the file server 203, and thereafter, the storing completion notification e-mail is transmitted to the recipient's e-mail address associated with the directory.

Where “STORE FILE IN SERVER” is chosen, the document is read and converted into the file, and the file is only stored in the file server 203. The storing completion notification e-mail is not transmitted to the recipient's e-mail address associated with the directory.

Where “TRANSMIT NOTIFICATION E-MAIL” is chosen, the storing completion notification e-mail is transmitted to the recipient's e-mail address associated with the directory based on the file information. The user can choose this to store the multiple files in the file server 203, and thereafter, the user can transmit the storing completion notification e-mail for the multiple stored files.

FIG. 13 is an example of the file information used in the second embodiment of the present invention. In addition to the items of the file information 600 in FIG. 6, the file information 1300 has a duration 1303. The duration 1303 determines a time for which the corresponding record in the file information is maintained in the memory unit 1006 of the MFP 1000. The time management unit 1008 deletes the record in the file information that has been stored for the duration 1303 or more based on the duration 1303, the current time, and the storing date and time as to when the file is stored.

FIG. 14 is an example of the selection screen where only the storing completion notification e-mail is transmitted according to the second embodiment of the invention. The display unit 1005 displays, as a file information 1401 about the files stored in the file server 203, a storing location 1402, a storing date and time 1403 as to when the file is stored, an deletion date and time 1404 calculated based on the storing date and time and the duration 1303.

The user touches arrow buttons 1405 and 1406 to move up and down the cursor and touches a select button 1407 to decide the record. Where the user decides the selected record, a checkmark 1408 is displayed beside the selected record. Upon selection, the user touches a transmit button 1410 to instruct the MFP to transmit the storing completion notification e-mail.

The user can delete the record in the file information that does not need to be notified via e-mail in the future by touching the arrow buttons 1405 and 1406 and the select button 1407 to select the record in the file information and touching the delete button 1409. Even if the user does not manually delete the record in the file information, the time management unit 1008 automatically respectively deletes the record in the file information that has been stored for the duration or more with the use of the storing date and time information and the duration 1303.

FIG. 15 is an example of the storing completion notification e-mail used in the second embodiment of the present invention. The MFP 1000 makes an e-mail body 1500 consisting of an e-mail body template 1501 and a file information 1502, and transmits the e-mail to the mail server 204. The user receiving the e-mail on the personal computer 205 can know that the document has been stored in the file server 203, and can know the directory in which the file is stored.

The operation of the second embodiment is hereinafter described with reference to FIGS. 10 to 17. FIG. 16 shows a processing flow of the initial configuration of the MFP 1000.

First, the file server configuration information 1100 as shown in FIG. 11 is configured. The user may configure each profile in the file server configuration information 1100 by inputting the information with the software keyboard displayed on the operation panel or by accessing the web-based configuration interface of the MFP 1000 with the personal computer 205 over the network.

At step S1601, the information about the file server 203 receiving the file transmitted by the MFP 100 is configured, that is, the profile name 1101, the file server address 1102, the protocol 1103, and the directory 1104 are configured.

At step S1602, the recipient's e-mail address 1105 corresponding to the directory is configured to allow transmission of the storing completion notification e-mail.

In addition to the recipient's e-mail address 1105, the e-mail template 1106 is configured. With the file server configuration information 1100 thus configured, the user has only to select the profile name 301 to store the file in the configured directory and transmit the storing completion notification e-mail to the recipient's e-mail address. Thereafter, the user configures a duration 1107 for which the memory unit 1006 maintains each record in the file information at step S1603.

FIG. 17 shows a processing flow where the storing completion notification e-mail is transmitted to notify the multiple files stored in the file server 203 after the multiple files are stored in the file server 203.

At step S1701, the MFP 1000 detects that the document to be read is placed. Then, the user operates the operation panel to select the profile to determine the file server to which the document is to be transmitted as the file.

At step S1702, the MFP 1000 accepts the selection of, for example, the profile “Accounting Division Second Team” on the operation panel. Then, the user selects “STORE FILE IN FILE SERVER” at step S1703 and touches the execution button at step S1704 where the user wishes to send the storing completion notification once for the multiple files after the multiple documents are stored in the file server as the files. Where the user wishes to send the storing completion notification e-mail for the single stored file, the user selects “STORE FILE IN FILE SERVER AND TRANSMIT NOTIFICATION E-MAIL”.

At step S1705, the MFP 1000 checks the e-mail transmission configuration 1202 stored in the memory unit 1006. Where the e-mail transmission configuration is other than “TRANSMIT NOTIFICATION E-MAIL”, the MFP 100 starts reading the document and temporarily saves the read image in the memory unit 1006 at step S1706. The image processing unit 1002 converts the memorized image into, for example, the file in PDF format at step S1707.

The MFP 1000 transmits the converted file to the file server directory 1104 of the file server address 1102 under the protocol 1103 at step S1708. When the file has been stored in the file server, it is determined whether the transmission has been completed normally at step S1709, and the file information is memorized in the memory unit 1006 and an update flag is set at step S1710.

Next, the MFP 1000 finally checks the update flag, and where the file information is determined to be updated at step S1711, the MFP 1000 checks the e-mail transmission configuration again at step S1712. Where the e-mail transmission configuration is “STORE FILE IN FILE SERVER AND TRANSMIT NOTIFICATION E-MAIL”, the MFP 1000 transmits the storing completion notification e-mail to the recipient's e-mail address 1105 at step S1713. Where the e-mail transmission configuration is “STORE FILE IN FILE SERVER”, the e-mail is not sent.

If the user has the subsequent document, the user repeats steps from step S1701 to store the subsequent document in the file server. If the file server has finished storing all of the documents that the user wishes to store in the file server, the user selects “TRANSMIT NOTIFICATION E-MAIL” in the e-mail transmission configuration 1202 and touches the execution button 1207.

The display unit 1005 displays the file information 1401 showing the list of files successfully stored in the file server. At step S1714, the user selects a record in the file information that the user wishes to notify in the storing completion notification e-mail by touching the arrow buttons 1405 and 1406 to move up and down the cursor and touching the selection button 1407. After the user has selected all of the records in the file information file that the user wishes to notify, the user touches the transmission button 1410 at step 1715.

With the second embodiment of the present invention as described above, the single storing completion notification e-mail can include information as to the multiple files that have been stored in the server where the multiple files are stored in the server, and thus, the second embodiment of the present invention is advantageous in relieving the user from receiving the multiple redundant notification e-mails.

In the embodiments, the information processing apparatus is described as the MFP, but the present invention can be applied to a scanner, a photocopier, a facsimile machine, and a digital camera.

In the embodiments, the file server and the information processing apparatus are connected via the network, but the present invention is not limited thereto. A function of the file server can be incorporated into the MFP to enable the file transfer therebetween without the network.

In the embodiments, the memory unit of the MFP maintains the file information including records of files that have been successfully transferred to and stored in the server. However, the MFP does not necessarily have the file information in the memory unit thereof, and instead, the MFP may access the file server as necessary to retrieve a list of files stored in the file server and timestatups of the files, and use the retrieved file list and the timestamps as a substitute for the file information. In this way, the MFP can accurately obtain the list of files stored in the server without having the file information in the memory unit of the MFP even if the user manually changes or deletes the file in the server.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention should not be limited by the specification, but be defined by the claims set forth below.

What is claimed is:

1. An information processing apparatus comprising:
an information memory unit memorizing a location information identifying a location in which a file is to be stored and an e-mail recipient information associated with the location information;
a file information memory unit memorizing a file information comprised of a file location information of a location in which the file is stored and a date and time as to when the file is stored;
a storing determination unit watching the file information to determine whether the file is newly stored; and
a communication unit transmitting an e-mail including the file information about the newly stored file to a user whose email address is previously registered in the e-mail recipient information where the storing determination unit determines that the file is newly stored in the location of the file location information.

2. The information processing apparatus according to claim 1, wherein the communication unit transmits the e-mail including the file information about a plurality of the files.

3. An information processing system comprising:
the information processing apparatus according to claim 1 further having an image scanner unit; and
a memory apparatus storing the file transmitted from the information processing apparatus.

4. An information processing system comprising:
the information processing apparatus according to claim 1 further having a camera unit; and
a memory apparatus storing the file transmitted from the information processing apparatus.

5. An information processing apparatus comprising:
a file memory unit storing a file; and
a profile memory unit memorizing a plurality of profiles, any one of the plurality of profiles including a location information and a recipient information,
wherein after a user selects one of the plurality of profiles, the information processing apparatus transmits the file to a location specified in the location information of the one of the plurality of profiles selected by the user, and thereafter, the information processing apparatus transmits a notification to a recipient specified in the recipient information of the one of the plurality of profiles selected by the user.

6. The information processing apparatus according to claim 5, wherein the notification includes the location information of the file successfully transmitted to and stored in the location.

7. The information processing apparatus according to claim 5, wherein the notification includes the location information of a plurality of the files successfully transmitted to and stored in the location.

8. The information processing apparatus according to claim 5, wherein the location information includes a network address of a server receiving the file transmitted by the information processing apparatus.

9. The information processing apparatus according to claim 8, wherein the network address is an IP address of the server.

10. The information processing apparatus according to claim 8, wherein the network address is a host name and/or domain name of the server.

11. The information processing apparatus according to claim 5, wherein the one of the plurality of profiles further includes a protocol information of a protocol under which the information processing apparatus transmits the file.

12. The information processing apparatus according to claim 5, wherein the location information includes a directory path in which the server stores the received file.

13. The information processing apparatus according to claim 5, wherein the one of the plurality of profiles further includes a template information of a template of the notification.

14. An information processing system comprising:
the information processing apparatus according to claim 5 further having an image scanner unit reading an image and saving the read image as the file in the memory unit; and
a storing apparatus storing the file transmitted from the information processing apparatus.

15. An information processing system comprising:
the information processing apparatus according to claim 5 further having a camera unit saving an image as the file in the memory unit; and
a storing apparatus storing the file transmitted from the information processing apparatus.

16. An information processing method comprising the steps of:
allowing a user to select one of a plurality of profiles, any one of the plurality of profiles including a location information and a recipient information;
transmitting a file to a location specified in the location information of the one of the plurality of profiles selected by the user; and
transmitting a notification to a recipient specified in the recipient information of the one of the plurality of profiles selected by the user.

17. The information processing method according to claim 16, wherein the notification includes the location information of the file successfully transmitted to and stored in the location.

18. The information processing method according to claim 16, wherein the notification includes the location information of a plurality of the files successfully transmitted to and stored in the location.
